(19) United States
(12) Patent Application Publication
(10) Pub. No.: US 2014/0310323 A1
(43) Pub. Date: Oct. 16, 2014

(54) STORAGE DEVICE PERMITTING FILE STORAGE ACCORDING TO EXTENSION, METHOD OF CONTROLLING THE SAME, PROGRAM, AND STORAGE MEDIUM

(71) Applicant: CANON KABUSHIKI KAISHA, Tokyo (JP)

(72) Inventor: Satoru Nakajima, Yokohama-shi (JP)

(73) Assignee: CANON KABUSHIKI KAISHA, Tokyo (JP)

(21) Appl. No.: 14/365,767

(22) PCT Filed: Jan. 17, 2013
(86) PCT No.: PCT/JP2013/051365

§ 371 Date: Jun. 16, 2014

(30) Foreign Application Priority Data
Jan. 20, 2012 (JP) 2012-010100

(51) Int. Cl. G06F 17/30

(52) U.S. Cl. CPC G06F 17/3012; G06F 17/30218
USPC 707/823

(57) ABSTRACT

A storage device which enables a user to set types of files permitted to be stored without regard to extensions of the files. An image forming apparatus includes a HDD having a plurality of folders for storing files therein. A document management section extracts an extension of a file to be stored in an extension folder. The document management section manages the extracted extension as an extension specifying a type of files permitted to be stored in the plurality of folders.

### TECHNICAL FIELD

The present invention relates to a storage device, a method of controlling the same, a program, and a storage medium, and more particularly to a technique for storing and managing files.

### BACKGROUND ART

Conventionally, an image forming apparatus having a function for storing and managing document files has been brought into practical use. This function is called a box function, and enables the image forming apparatus to store data scanned by a scanner function thereof, and store document files created by an application on a personal computer (PC) and received therefrom via a network. Further, it is also possible to view and edit document files stored in a box (storage area) of the image forming apparatus from the PC connected to the network.

The image forming apparatus is also capable of selecting whether or not to permit document files to be written from the PC into the box. In a case where the writing of document files is not permitted, it is possible to view document files in the box from the PC but impossible to edit them or store new document files in the box from the PC.

Further, it is possible to permit the image forming apparatus to store only document files having specific extensions in the box. By registering extensions of document files permitted to be stored, in advance, unless a document file desired to be stored has an extension registered in the image forming apparatus, it is possible to prevent the document file from being stored. To add an extension for permission of storage of files, it is required to change an associated program to be changed, and it is inefficient when time required for the change and expandability are taking into consideration. In view of this, there has been proposed a method of easily changing conditions of storage of a file without changing the program (for example, see PTL 1).

### CITATION LIST

### Patent literature

PTL 1: JP 2011-61563 A

### SUMMARY OF INVENTION

### Technical Problem

However, according to PTL 1, specific users such as administrators are permitted to change the conditions of storage of files on a file server-by-file server basis by operation from a console section of the image forming apparatus. In this case, it is necessary to make all possible conditions of storage which might be changed, ready to be applied, beforehand. For example, in a case where an extension as a condition of storage is to be changed, it is required to make all extensions of document files which can be created by various document creation applications ready to be applied, beforehand, so as to enable such a specific user to select from them.

Further, a user who configures conditions of storage needs to comprehend what document creation application gives the extension of document files permitted to be stored. Further, some document creation applications create a temporary file for the backup of data of editing upon opening of a document file. The temporary file is sometimes given a different extension from that of the document file, which is difficult for the user to comprehend.

The present invention has been made in view of these problems, and provides a storage device which enables a user to set types of files permitted to be stored without regard to extensions of the files, a method of controlling the same, a program, and a storage medium.

### Solution to Problem

Accordingly, in a first aspect of the present invention, there is provided a storage device, comprising a storage unit having a plurality of folders and configured to store files in the folders, an extraction unit configured to extract an extension of a file to be stored in a specific folder, and a management unit configured to manage the extension extracted by the extraction unit as an extension specifying a type of files permitted to be stored in the plurality of folders.

Accordingly, in a second aspect of the present invention, there is provided a storage device, comprising a storage unit having a plurality of folders and configured to store files in the folders, an extraction unit configured to extract extensions of files to be stored in the specific folder, and a management unit configured to manage any of the extensions extracted by the extraction unit, selected by a specific user, as extensions specifying types of files permitted to be stored in the plurality of folders.

Accordingly, in a third aspect of the present invention, there is provided a method of controlling a storage device including a storage unit having a plurality of folders and configured to store files in the folders, comprising extracting an extension of a file to be stored in a specific folder, and managing the extension extracted by the extracting as an extension specifying a type of files permitted to be stored in the plurality of folders.

Accordingly, in a fourth aspect of the present invention, there is provided a method of controlling a storage device including a storage unit having a plurality of folders and configured to store files in the folders, comprising extracting extensions of files to be stored in the specific folder, and managing any of the extensions extracted by the extracting, selected by a specific user, as extensions specifying types of files permitted to be stored in the plurality of folders.

Accordingly, in a fifth aspect of the present invention, there is provided a computer-executable program for causing a storage device to execute the method.

Accordingly, in a sixth aspect of the present invention, there is provided a non-transitory computer-readable storage medium storing the computer-executable program.

### Advantageous Effects of Invention

According to the present invention, it is possible for a user to set types of files to be permitted to be stored without regard to extensions of the files.

Further features of the present invention will become apparent from the following description of exemplary embodiments with reference to the attached drawings.

### BRIEF DESCRIPTION OF DRAWINGS

FIG. 1 is a schematic block diagram showing the hardware configuration of an image forming apparatus which is an example of a storage device according to an embodiment of the present invention.

FIG. 2 is a diagram showing an example of folders in a region which a user can access.

FIG. 3 is a schematic block diagram showing the software configuration of the image forming apparatus.

FIG. 4 is a flowchart of a process for controlling access to an extension folder, which is performed in the first embodiment.

FIG. 5 is a flowchart of a document file storage process performed in the first embodiment.

FIG. 6 is a flowchart of a document file storage process performed in a second embodiment of the present invention.

FIG. 7 is a flowchart of a process for acquiring a list of extensions waiting for storage permission, which is performed in the second embodiment.

FIG. 8 is a flowchart of a process for adding an extension to a list of extensions for which storage is permitted, which is performed in the second embodiment.

FIG. 9A is a diagram showing an example of definition of the list of extensions waiting for storage permission.

FIG. 9B is a diagram showing an example of a selection screen for selecting extensions of document files to be permitted to be stored.

### DESCRIPTION OF EMBODIMENTS

The present invention will now be described in detail below with reference to the drawings showing an embodiment thereof.

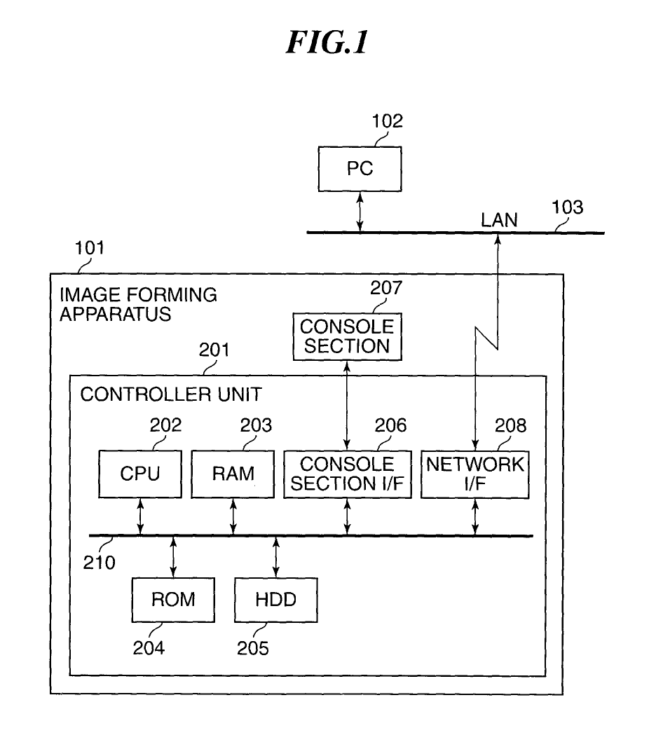

FIG. 1 is a schematic block diagram showing the hardware configuration of an image forming apparatus which is an example of a storage device according to an embodiment of the present invention. Note that a network environment is not limited to the illustrated example, but the present embodiment may be applied to a network environment in which a plurality of image forming apparatuses and a plurality of PCs are connected to a network.

The image forming apparatus, denoted by reference numeral 101, is connected to a personal computer (PC) 102 via a LAN 103.

A controller unit 201 of the image forming apparatus 101 comprises a CPU 202, a RAM 203, a ROM 204, a hard disk drive (HDD) 205, a console section interface 206, and a network interface 208. The CPU 202 is a controller that controls the whole system. The RAM 203 is a system work memory used by the CPU 202 for operation. The ROM 204 is a boot ROM that stores a boot program of the system. The HDD 205 is a storage device that stores system software, document files, data files for use in managing the document files, and so forth. The function of managing the document files by using the data files is called a box function.

The console section interface 206 is a section that provides an interface with a console section 207 and outputs to the console section 207 information to be displayed on the console section 207. Further, the console section interface 206 serves to transmit information input by a user from the console section 207 to the CPU 202. The network interface 208 connects to the network (LAN) 103, and inputs and outputs information to and from PCs including the PC 102 and other image forming apparatuses, which are connected to the same LAN. The above-mentioned devices are arranged on a system bus 210. Further, image input/output devices, such as a scanner and a printer, not shown, are connected to the controller unit 201.

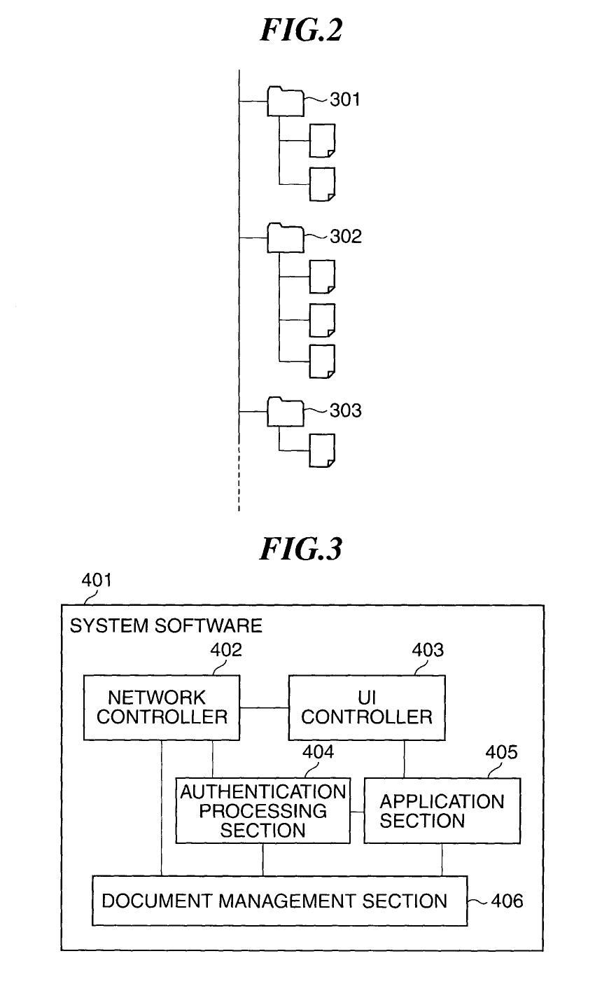

Folders are created in the HDD 205, and document files, data files, etc. are stored in the folders. The folders created in the HDD 205 are classified into folders in a region where only the system of the image forming apparatus 101 can internally access and folders in a region which users can access. Each user can store document files and the like, in the holders in the region which users can access, and can view, edit, delete, and output the stored document files. An example of the folders in the region which users can access is shown in FIG. 2.

In the illustrated example, three folders, i.e. a folder 301, a folder 302 and a folder 303 store two pieces of data, three pieces of data, and one piece of data, respectively. Note that the number of folders is not limited to three, and folders may have a layered structure.

A method of storing data in a folder includes, for example, one in which an image is read using a scanner function of the image forming apparatus 101 and image data thus acquired is stored in the folder as a document file. Another one is that a folder is directly accessed by the PC 102 using a protocol, such as FTP, SMB, or WebDAV, and then the PC 102 stores a document file in the folder.

The folder and the stored document files can be viewed from the console section 207. If there are a plurality of folders and document files, a list of the folders and document files is displayed on the console section 207. By selecting a desired document file from the list of the folder and document files, the user can perform an operation on the selected document file, and can perform processing, such as preview display, property display, page insertion, move/copy to another folder, document file deletion, or print.

FIG. 3 is a schematic block diagram showing the software configuration of the image forming apparatus 101.

System software 401 is stored in one of the storage units of the RAM 203, the ROM 204, and the HDD 205, and is executed by the CPU 202.

A network controller 402 receives instructions from the PC 102, an image forming apparatus, not shown, etc. connected to the LAN 103, via the network interface 208. Then, the network controller 402 requests one of a user interface controller 403, an authentication processing section 404, and a document management section 406, to perform processing according to the received instructions. Further, the network controller 402 receives instructions and responses from the user interface controller 403, the authentication processing section 404, and the document management section 406, and transmits the received instructions and responses to the PC 102, the image forming apparatus, not shown, etc. connected to the LAN 103, via the network interface 208.

The user interface controller 403 receives the information input by the user using the console section 207 via the console section interface 206, and receives instructions from the network controller 402. Then, the user interface controller 403 requests an application section 405 to perform processing according to the received information and instructions. Further, the user interface controller 403 receives responses from the application section 405, and displays the responses on the console section 207 via the console section interface 206 and transmits them to the network controller 402.

The authentication processing section 404 receives authentication requests from the network controller 402 and the application section 405, and transmits responses to the requests. Further, the authentication processing section 404 receives an authentication acknowledgement request from the document management section 406, and transmits a response to the authentication acknowledgement request. The user interface controller 403 also has a Web server function of interpreting and creating Web pages written in HTML (Hyper Text Markup Language) or the like. The network controller 402 receive Web pages by making use of HTTP (Hyper Text Transfer Protocol) or the like. The user interface controller 403 interprets Web pages received by the network controller 402, creates Web pages for response, and transmits the created Web pages for response to the network controller 402.

The application section 405 receives instructions from the user interface controller 403 and requests the authentication processing section 404 and the document management section 406 to perform processing according to the received instructions. Further, the application section 405 receives responses from the authentication processing section 404 and the document management section 406 and transmits the responses to the user interface controller 403.

The document management section 406 receives requests for information on folders and document files from the network controller 402 and the application section 405. According to the requests, the document management section 406 handles folders and document files which are stored and managed in the HDD 205 or creates new document files and folders, and then transmits the results. Further, the document management section 406 transmits an authentication acknowledgement request to the authentication processing section 404 and receives a response to the authentication acknowledgement request.

Further, the document management section 406 also performs processing for determining whether or not a document file can be stored (memorized), according to an extension of the document file. A list of extensions of document files permitted to be stored are stored in the RAM 203, and when a request for storing a document file whose extension does not exist in this list is received, the document management section 406 does not store the document file. Further, the document management section 406 manages user's access rights to folders and document files which are stored and managed. Further, the document management section 406 determines whether a folder or document file can be viewed or edited, according to a user having accessed the folder or document file.

Next, a description will be given of processing for adding an extension of document files permitted to be stored, by using the system software 401.

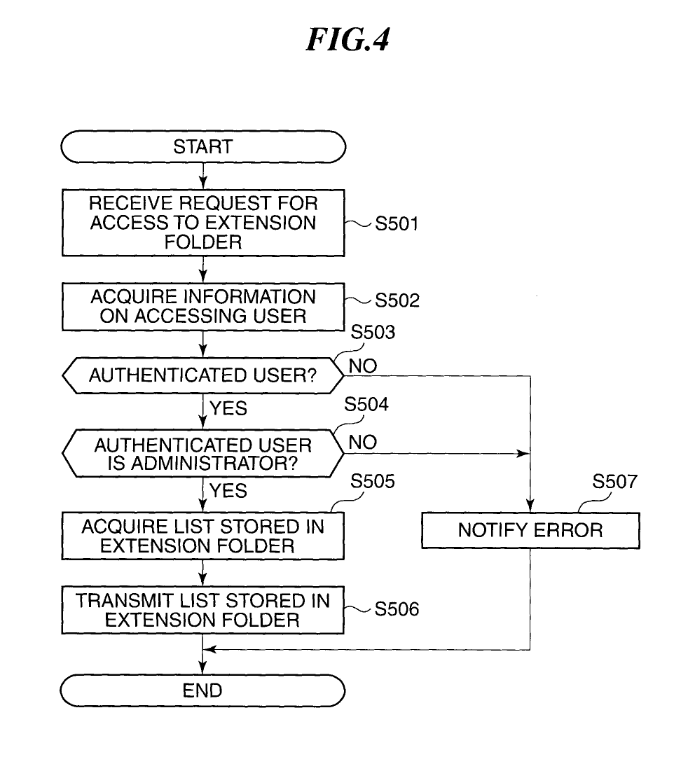

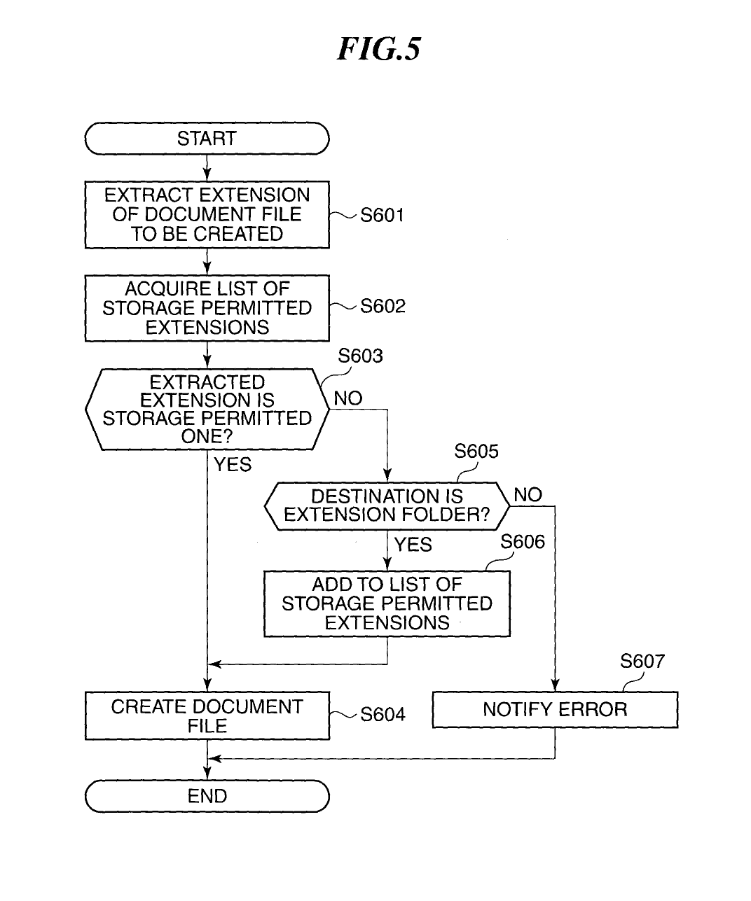

FIG. 4 is a flowchart of a process for controlling access to an extension folder, which is executed by the system software 401. A program of the present process is executed by the CPU 202.

The extension folder is a specific folder used for adding extensions of document files permitted to be stored. In the present embodiment, the extension folder is one of folders created in the HDD 205. The extension folder is permitted to be accessed only by specific users who have administrative privileges. Further, when storing a document file in the extension folder, the processing for determining whether or not a document file can be stored, according to an extension of the document file, is not performed. That is, no matter what extension the document file has, the document file can be stored.

First, the user sends an access request to the extension folder of the image forming apparatus 101 by FTP, SMB, WebDAV, or the like protocol, using the PC 102 or the like. The network controller 402 receives the access request (step S501) and acquires information on the accessing user from the information of the received access request (step S502).

Next, the network controller 402 queries the authentication processing section 404 as to whether or not the accessing user is authenticated (step S503), and if it is determined that the accessing user is not authenticated, the network controller 402 sends an error notification to the access request source (step S507), followed by terminating the present process. On the other hand, if it is determined that the accessing user is authenticated, the network controller 402 requests a list stored in the extension folder to the document management section 406. The list stored in the extension folder refers to the list of folders and document files stored and managed in the extension folder. Note that this operation is not an operation directly related to the access itself, and hence processing therefor is not shown as a step in FIG. 4.

Next, the document management section 406 queries the authentication processing section 404 as to whether or not the authenticated user is an administrator (step S504), and if it is determined that the authenticated user is not an administrator, the authentication processing section 404 sends an error notification to the access request source (step S507), followed by terminating the present process. On the other hand, if it is determined that the authenticated user is an administrator, the network controller 402 acquires the list stored in the extension folder (step S505), transmits the acquired list to the access request source via the network interface 208, followed by terminating the present process (step S506).

The above-described process enables the administrator to access the extension folder, whereby the administrator can create and store document files in the extension folder from the PC.

FIG. 5 is a flowchart of a document file storage process executed by the system software 401. A program of the present process is executed by the CPU 202.

The user as an administrator performs an operation to store, in the extension folder, a document file of a type desired to have an extension thereof set as that of document files permitted to be stored. In response to the operation, the PC 102 transmits a document file creation request to the image forming apparatus 101.

Upon receipt of the document file creation request from the PC 102, the network controller 402 sends the document file creation request to the document management section 406. The document management section 406 extracts an extension from the information on the document file in the document file creation request (step S601). Then, the document management section 406 acquires a list of storage permitted extensions stored in the RAM 203 (step S602). The list of storage permitted extensions refers to a list of extensions of document files permitted to be stored, mentioned hereinabove.

Next, the document management section 406 determines whether or not the extension extracted in the step S601 is a storage permitted extension (step S603). Specifically, the document management section 406 compares the extension extracted in the step S601 with the list of storage permitted extensions, and if the extracted extension is included in the list of storage permitted extensions, it is determined that the extracted extension is a storage permitted extraction, and then the CPU 202 proceeds to a step S604.

In the step S604, the document management section 406 creates a document file in a designated folder, followed by terminating the present process.

On the other hand, if it is determined in the step S603 that the extension extracted in the step S601 is not included in the list of storage permitted extensions, it is determined that a document file having the extracted extension is not permitted to be stored, and the CPU 202 proceeds to a step S605.

In the step S605, the document management section 406 determines whether or not a destination folder where the document file is to be stored is the extension folder. If it is determined that the destination folder is the extension folder, the document management section 406 adds the extension extracted in the step S601 to the list of storage permitted extensions (step S606), and then the CPU 202 proceeds to the step S604. On the other hand, if the destination folder is not the extension folder, the document file cannot be stored, and hence the document management section 406 sends an error notification to the document file creation request source (step S607), followed by terminating the present process.

According to above-described document file storage process, when an ordinary folder is accessed, the administrator cannot store therein a document file whose extension is not a storage permitted one, but when the extension folder is accessed, the administrator can store the document file therein. In this case, the extension of the document file is added to the list of storage permitted extensions.

When opening the document file stored in the extension folder by using an application in the PC 102, the application sometimes creates a temporary file for the backup of data of editing. If an extension of the temporary file has not been registered, the temporary file cannot be stored. If the temporary file cannot be stored, a document creation application can open the document file only for reading, but cannot edit it. Even in such a case, the document management section 406 receives a request for creation of the temporary file, and hence by executing the document file storage process shown in FIG. 5, if the extension of the temporary file is not a storage permitted one, the extension will be added to the list of storage permitted extensions.

According to the document file storage process shown in FIG. 5, the user as an administrator performs an operation to store, in the extension folder, a document file of a type desired to have an extension thereof set as that of document files permitted to be stored, and further performs an operation to open the stored file. By performing such easy operations, it is possible to set the same type of files as the file and the temporary file created by opening the file, as the files permitted to be stored.

Next, a description will be given of a second embodiment of the present invention. In the present embodiment, when adding an extension of document files permitted to be stored, the addition of the extension is executed after prompting an user to perform selection. Note that the second embodiment has the same arrangement and configurations as those of the above-described first embodiment shown in FIGS. 1 to 3, and therefore the same component parts and elements as those of the first embodiment are denoted by the same reference numerals, and description thereof is omitted. Further, the process for controlling access to the extension folder is the same as that described with reference to FIG. 4 except that the step S504 for determining whether the authenticated user is an administrator is omitted, and hence description thereof is omitted. The following description is given of points different from the first embodiment.

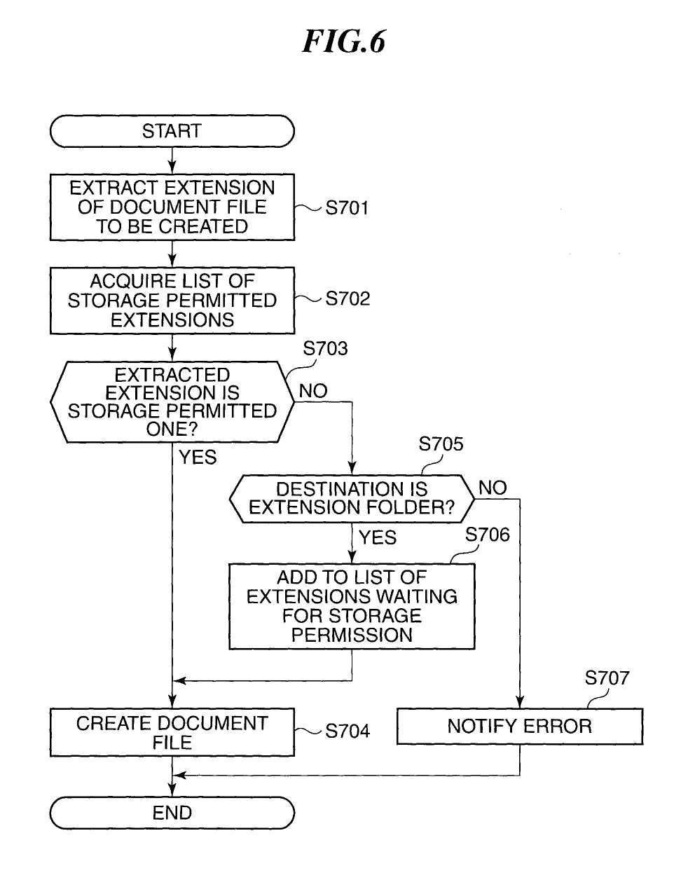

FIG. 6 is a flowchart of a document file storage process executed by the system software 401. A program of the present process is executed by the CPU 202.

A user (for example, a general user) performs an operation to store, in the extension folder, a document file of a type desired to have an extension thereof set as that of document files permitted to be stored. In response to the operation, the PC 102 transmits a document file creation request to the image forming apparatus 101.

Upon receipt of the document file creation request from the PC 102, the network controller 402 sends the document file creation request to the document management section 406. The document management section 406 extracts an extension from the information on the document file in the document file creation request (step S701). Then, the document management section 406 acquires the list of storage permitted extensions stored in the RAM 203 (step S702). The list of storage permitted extensions refers to a list of abovementioned extensions of document files permitted to be stored.

Next, the document management section 406 determines whether or not the extension extracted in the step S701 is a storage permitted one (step S703). Specifically, the document management section 406 compares the extension extracted in the step S701 with the list of storage permitted extensions, and if the extracted extension is included in the list, it is determined that the extracted extension is a storage permitted one, and the CPU 202 proceeds to a step S704.

In the step S704, the document management section 406 creates a document file in a designated folder, followed by terminating the present process.

On the other hand, if, it is determined in the step S703 that the extension extracted in the step S701 is not included in the list of storage permitted extensions, it is determined that the extracted extension is not a storage permitted one, and the CPU 202 proceeds to a step S705.

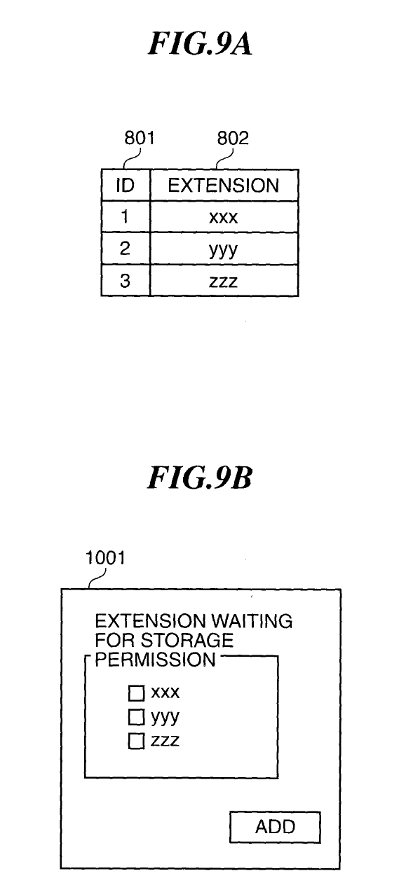

In the step S705, the document management section 406 determines whether or not a destination folder is the extension folder. If the destination folder is the extension folder, the document management section 406 adds the extension extracted in the step S701 to a list of extensions waiting for storage permission (step S706), and the CPU 202 proceeds to processing in the step S704. This list of extensions waiting for storage permission refers to a list of extensions of document files which are stored in the extension folder but are not included in the list of extensions of document files permitted to be stored, and is stored in the RAM 203. Note that the list of extensions waiting for storage permission may be stored in the HDD 205 as a data file. An example of the list of extensions waiting for storage permission is shown in FIG. 9A.

In FIG. 9A, the list of extensions waiting for storage permission is composed of IDs 801 for identifying extensions to be added, respectively, and extensions 802 which are waiting for storage permission. In the illustrated example, “xxx”, “yyy” and “zzz” are stored as extensions waiting for storage permission.

If it is determined in the step S705 that the destination is not the extension folder, since the document file cannot be stored, the document management section 406 sends an error notification to the document file creation request source (step S707), followed by terminating the present process.

According to above-described document file storage process, when an ordinary folder is accessed, the user cannot store therein a document file whose extension is not a storage permitted one, but when the extension folder is accessed, the user can store the document file therein. In this case, the extension of the document file is added to the list of extensions waiting for storage permission. At the time when the extension of the document file is added to the list of extensions waiting for storage permission, the file having the extension cannot be stored in other folders than the extension folder. However, as described hereinafter, by adding the extension added to the list of extensions waiting for storage permission to the list of storage permitted extensions, it is possible to store the file having the extension in folders other than the extension folder.

When the document file stored in the extension folder is opened by using an application in the PC 102, the application sometimes generates a temporary file for the backup of data of editing. Even in such a case, the document management section 406 receives a request for generation of the temporary file, and hence if the extension of the temporary file is not a storage permitted one, it is added to the list of extensions waiting for storage permission.

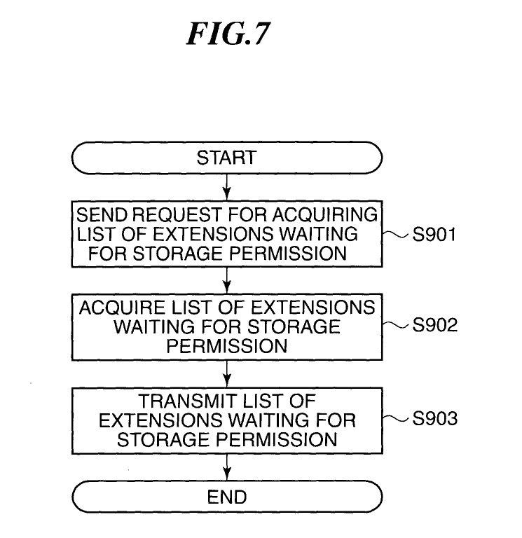

FIG. 7 is a flowchart of a process for acquiring the list of extensions waiting for storage permission which is executed by the system software 401. A program of the present process is executed by the CPU 202.

To cause a user (for example, a user as an administrator) to select an extension of document files permitted to be stored, it is possible to employ one of the following two methods: One is to display the list of extensions waiting for storage permission on the console section 207 according to a user's instruction and the other is to display the list of extensions waiting for storage permission by using a browser of the PC 102 (the PC that the user operates) on the LAN 103. In the case of selecting from the console section 207, according to the user's instruction, the user interface controller 403 sends a request for acquiring the list of extensions waiting for storage permission to the document management section 406 via the application section 405 (step S901). Similarly, in the case of selecting from the browser of the PC 102, according to the user's instruction, the network controller 402 transmits a received Web page to the user interface controller 403. The user interface controller 403 analyzes the HTML and sends a request for acquiring the list of extensions waiting for storage permission to the document management section 406 via the application section 405 (step S901).

Then, the document management section 406 acquires the list of extensions waiting for storage permission from the RAM 203 or the HDD 205 (step S902), and transmits the list of extensions waiting for storage permission to the application section 405 (step S903).

The application section 405 transmits the list of extensions waiting for storage permission to the user interface controller 403, and the user interface controller 403 displays a selection screen on the console section 207 via the console section interface 206. Alternatively, the application section 405 creates a Web page of a selection screen, and causes the Web page of the selection screen to be displayed on the browser of the PC 102, via the network controller 402. An example of the selection screen for selecting extensions of document files to be permitted to be stored is shown in FIG. 9B. In the case of the list of extensions waiting for storage permission shown in FIG. 9A, a screen for selecting “xxx”, “yyy” and “zzz” is displayed on the console section 207 or on the browser screen of the PC 102, as shown in FIG. 9B.

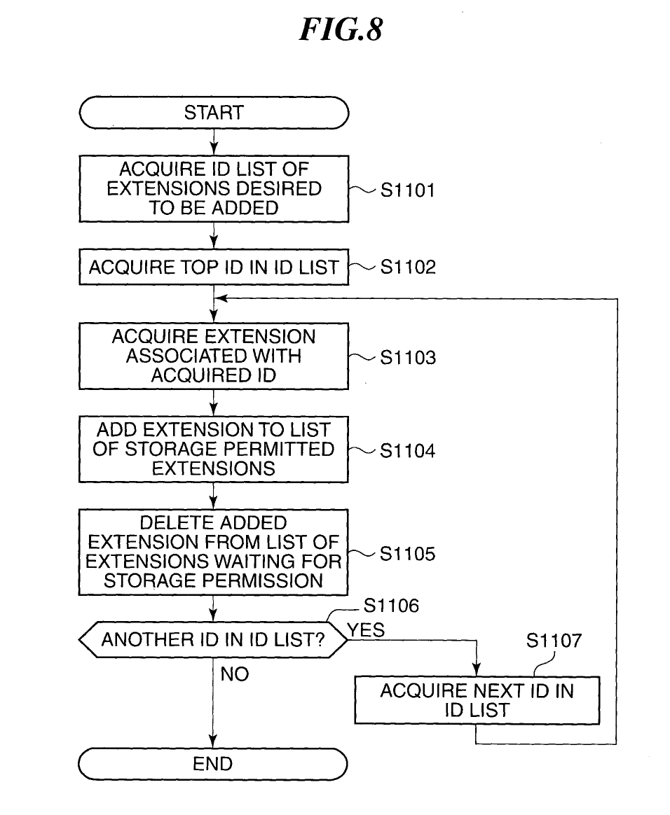

FIG. 8 is a flowchart of a process for adding an extension to the list of storage permitted extensions, which is executed by the system software 401. A program of the present processing is executed by the CPU 202.

When a user (for example, a user as an administrator) selects extensions of files which the user desires to permit to be stored from the above selection screen, and then sends a request for adding the extensions, a list of IDs associated with the selected extensions, respectively, is transmitted to the document management section 406 via the application section 405. The document management section 406 acquires the list of the IDs associated the selected extensions (step S1101) and acquires an ID at the top of the list (step S1102).

Next, the document management section 406 acquires an extension associated with the ID (step S1103), adds the extension to the list of storage permitted extensions (step S1104), and deletes this extension from the list of extensions waiting for storage permission (step S1105).

Next, the document management section 406 determines whether or not there is another ID in the list, that is, there is another extension which is wanting to be added (step S1106). If there is no other ID, the present process is immediately terminated, whereas if there is another ID, the document management section 406 acquires the next ID in the list (step S1107), and executes the steps S1103 et seq.

The above-described process enables the user to select and add extensions of document files permitted to be stored.

As described above, according to the second embodiment, for example, a general user stores, in the extension folder, a file of a type which the general user desires to permit to be stored, and opens the file stored in the extension folder, it is possible to add an extension of the file to the list of extensions waiting for storage permission. Then, for example, an administrator can select the extension added to the list of extensions waiting for storage permission and add the same to the list of storage permitted extensions. This procedure of operations makes it possible to perform such management that a general user makes an application to the administrator for an extension of files which the general user desires to permit to be stored, and the administrator approves the application to thereby enable files of the extension to be stored.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

### REFERENCE SIGNS LIST

101 image forming apparatus
102 PC
201 controller unit
202 CPU
401 system software
402 network controller
403 user interface controller
404 authentication processing section
405 application section
406 document management section

1. A storage device, comprising:
a storage unit having a plurality of folders and configured to store files in the folders;
an extraction unit configured to extract an extension of a file to be stored in a specific folder; and
a management unit configured to manage the extension extracted by said extraction unit as an extension specifying a type of files permitted to be stored in the plurality of folders.

2. The storage device according to claim 1, wherein the specific folder is a folder which only users having administrative privileges can access.

3. A storage device, comprising:
a storage unit having a plurality of folders and configured to store files in the folders;
an extraction unit configured to extract extensions of files to be stored in the specific folder; and
a management unit configured to manage any of the extensions extracted by said extraction unit, selected by a specific user, as extensions specifying types of files permitted to be stored in the plurality of folders.

4. The storage device according to claim 1, wherein the specific folder can store files other than the files of types specified by the extensions managed by said management unit.

5. The storage device according to claim 1, wherein the specific folder is one of the plurality of folders that said storage unit has.

6. A method of controlling a storage device including a storage unit having a plurality of folders and configured to store files in the folders, comprising:
extracting an extension of a file to be stored in a specific folder; and
managing the extension extracted by said extracting as an extension specifying a type of files permitted to be stored in the plurality of folders.

7. A method of controlling a storage device including a storage unit having a plurality of folders and configured to store files in the folders, comprising:
extracting extensions of files to be stored in the specific folder; and
managing any of the extensions extracted by said extracting, selected by a specific user, as extensions specifying types of files permitted to be stored in the plurality of folders.

8. A computer-executable program for causing a storage device to execute a method of controlling a storage device including a storage unit having a plurality of folders and configured to store files in the folders, comprising:
extracting an extension of a file to be stored in a specific folder; and
managing the extension extracted by said extracting as an extension specifying a type of files permitted to be stored in the plurality of folders; or comprising:
extracting extensions of files to be stored in the specific folder; and
managing any of the extensions extracted by said extracting, selected by a specific user, as extensions specifying types of files permitted to be stored in the plurality of folders.

9. A non-transitory computer-readable storage medium storing a computer-executable program for causing a storage device to execute the a method of controlling a storage device including a storage unit having a plurality of folders and configured to store files in the folders, comprising:
extracting an extension of a file to be stored in a specific folder; and
managing the extension extracted by said extracting as an extension specifying a type of files permitted to be stored in the plurality of folders; or comprising:
extracting extensions of files to be stored in the specific folder; and
managing any of the extensions extracted by said extracting, selected by a specific user, as extensions specifying types of files permitted to be stored in the plurality of folders.
